(19) United States
(12) Patent Application Publication
(10) Pub. No.: US 2015/0162854 A1
(43) Pub. Date: Jun. 11, 2015

(54) System and Method for Stimulating Rainfall

(71) Applicants: Nathan Blaunshtein, Beer-Sheva (IL); Alexander Bronshtein, Beer-Sheva (IL); Jacob Gitman, Sunny Isles Beach, FL (US); Sergey Pulinets, Troitsk (RU)

(72) Inventors: Nathan Blaunshtein, Beer-Sheva (IL); Alexander Bronshtein, Beer-Sheva (IL); Jacob Gitman, Sunny Isles Beach, FL (US); Sergey Pulinets, Troitsk (RU)

(73) Assignee: RPS INTERNATIONAL, Fort Lauderdale, FL (US)

(21) Appl. No.: 14/101,653

(22) Filed: Dec. 10, 2013

(51) Int. Cl. H02N 99/00

(52) U.S. Cl. CPC H02N 99/00

(57) ABSTRACT

For stimulating a rainfall, a plurality of electrically conducting elements are provided, which cover a substantially horizontal area, are supplied with a high voltage and generate in the substantially horizontal area a high voltage electric field providing in the atmosphere ionization of gas molecules which attract water and cause formation of a plurality of water clusters forming a cloud that produce a rainfall.

### BACKGROUND OF THE INVENTION

The present invention relates to systems and methods of artificial stimulation of rainfall in corresponding desired zones where it is needed and at a corresponding desired time when rainfall is needed.

Numerous methods for changing weather and in particular for rainfall stimulation have been developed and used with various degrees of success. One of such methods involves the use of a system including a high power vertical mast antenna which has a single vertical electrically conducting element creating a high electrical ionization potential in a background atmosphere above the antenna to ionize gas molecules and generate ions that attract water and form clusters which eventually can lead to formation of a cloud that causes rainfall. This above -identified system with the vertical mast antenna and with a single vertical electrically conducting element is shown in FIG. 1. It possesses however significant drawbacks. During the interaction of a huge electrical field energy generated by the single vertical electrically conducting element a local instability with huge turbulence is produced, which consumes the major energy for turbulence generation, instead of using it for ionization of gas molecules in the atmosphere for creation of ions that attract water to form clouds.

It is therefore believed that further substantial improvements in systems and method of artificially stimulating rainfalls is greatly desirable.

### SUMMARY OF THE INVENTION

Accordingly it is an object of the present invention to provide a new system of stimulation of rainfall and a method of stimulation of rainfall, which are further improvements of the existing systems and methods of this type.

In keeping with these objects and with others which will become apparent hereinafter, one features of the present invention resides, briefly stated, in a system of stimulating a rainfall, comprising a plurality of electrically conducting elements which cover a substantially horizontal area and are constructed, when supplied with a high voltage, to generate in the substantially horizontal area a high voltage electric field providing in ₜhe atmosphere ionization of gas molecules which attract water and cause formation of a plurality of water clusters forming a cloud that produces a rainfall.

When the system of stimulating a rainfall is constructed in accordance with the present invention, it eliminated the disadvantages of the known systems and provides a stable, efficient and highly effective process of forming clouds which produce rainfalls.

In accordance with a further feature of the system according to the present invention, the electrically conducting elements of the system includes first electrically conducting elements which are arranged along a periphery of the system one after another, and second electrically conducting elements which extend from the first electrically conducting elements toward a center of the system.

In accordance with a further new feature of the system of the present invention, the electrically conducting elements can be constructed as individual electrical conductors which are electrically connected with each other to form the inventive system.

In accordance with a still further feature of the system of the present invention, the electrically conducting elements can be constructed as a single one-piece electrical conductor which is shaped to form the plurality of the electrically conducting elements.

Still a further feature of the present invention resides in that the electrically conducting elements of the inventive system are constructed as multi-wire electrically conducting elements.

In a still further feature of the present invention, the electrically conducting elements of the inventive system are constructed to heat the atmosphere and thereby to provide a vertical upward flow of the ions and a vertical upward flow of the clusters to a desired height of the cloud to be formed.

In accordance with still a further feature of the present invention the electrically conducting elements are constructed to cover the substantially horizontal area which is a fraction of a horizontal area of the cloud that is desired to be formed.

According to still a further feature of the present invention, the inventive system for stimulating a rainfall has means which stimulate a transport of the cloud in a predetermined desired direction.

Still a further feature of the present invention resides in that the inventive system is provided with an electrical source constructed to supply a high voltage to the electrically conducting elements of the system.

The electrical source of the system can be provided with a controller for controlling electric parameters of the electric voltage supplied by the electrical source to the electrically conducting elements.

The present invention also deals with a method of stimulating a rainfall, comprising the steps of providing a plurality of electrically conducting elements which cover a substantially horizontal area, and supplying a high voltage to the electrically conducting elements, to generate in the substantially horizontal area a high voltage electric field providing in the atmosphere ionization of gas molecules which attract water and cause formation of a plurality of water clusters forming a cloud that produce a rainfall.

The novel features of the system and method in accordance with the present invention are set forth in particular in the appended claims.

The invention itself, however, will be best understood from the following description of the preferred embodiments which is accompanied by the following drawings.

### BRIEF DESCRIPTION OF THE DRAWINGS

FIG. 1 of the drawing is a view schematically showing a system for stimulating a rainfall, which was known before the present invention; and

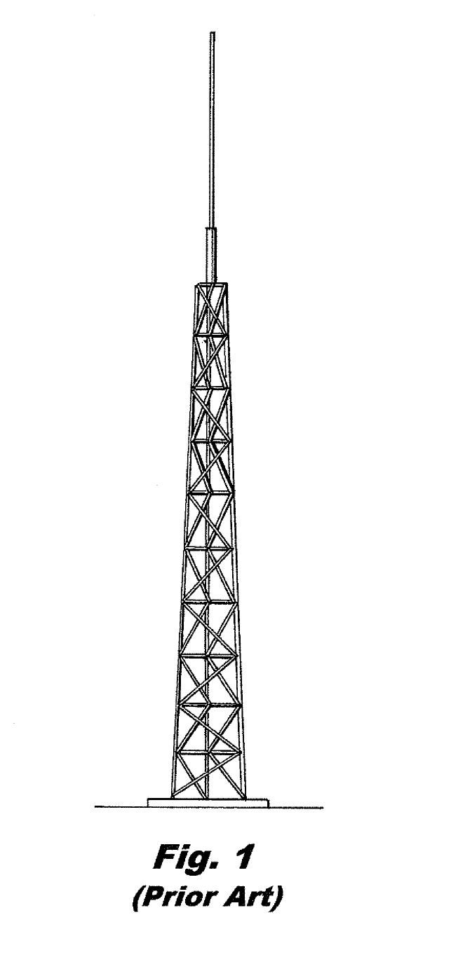

FIG. 2 is a view showing a new system for stimulation of a rainfall in accordance with the present invention, with which a new inventive method for stimulation of a rainfall is implemented.

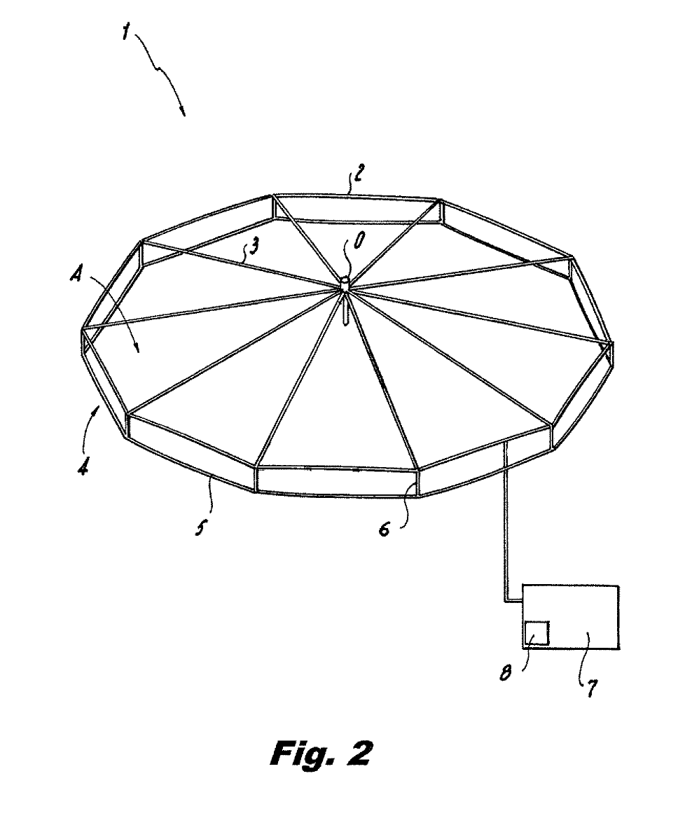

### DESCRIPTION OF PREFERRED EMBODIMENTS

A new system of stimulation of a rainfall which implements a new method of stimulation of a rainfall is identified as a whole with reference numeral 1. It has a plurality of electrically conducting elements, which can include first electrically conducting elements 2 that extend peripherally. The first electrically conducting elements 2 can be peripherally electrically connected with one another. The system further includes second electrically conducting elements 3 which extend towards the center O of the system. They can be electrically connected with the first electrically conducting elements 2. Furthermore, they can be also electrically connected with each other in the center 0 of the system 1. On the other hand, in the center of the system 1 the second electrically conducting elements 3 can be just supported by a central frame member. The electrically conducting elements 2 and 3 extend substantially horizontally. On the other hand, they can also extend at a small angle to a horizontal plane, for example up to 15-20 degrees.

The electrically conducting elements 2 and 3 are supported above ground by a frame 4 that includes substantially horizontal frame elements 5 and substantially vertical frame elements 5, that can be connected with one another.

The system 1 including the electrically conducting elements 2 and 3 covers a significant substantially horizontal area A. The electrically conducting elements 2 and 3 are supplied with a high voltage, so that they carry the high voltage and generate in the substantially horizontal area a high voltage electric field which causes a movement of atmospheric ions, causes generation of ions from the electrically conductive elements, and provides in the atmosphere ionization of gas molecules. The ions attract water and cause formation of a plurality of water clusters which eventually form a cloud that can produce a rainfall.

The system 1 is provided for this purpose with a source of a high voltage 7 which is connected with at least one of the electrically conductive elements 2 and 3 and can be formed as an electrical generator. It can be provided with a controller 8 which regulates the electrical parameters of the electrical voltage supplied to the individual electrically conducting elements 2 and 3 and to the system as a whole. The voltage supplied to the electrically conducting element can be up to 100 KV, while the system can usually operate with a nominal voltage of 20-30 KV to provide a desired high voltage electrical field in the area A.

The electrically conducting elements 2 and 3 can be constructed as individual electrical conductors which are substantially electrically connected with each other to form the inventive system. On the other hand, the electrically conducting elements can be constructed as a single one-piece electrical conductor which is shaped and arranged to form the plurality of the electrically conducting elements 2 and 3.

The electrically conducting elements 2 and 3 of the inventive system 1 can be constructed as multi-wire electrically conducting elements, each containing a plurality, for example 7-15 wire conductors. As a result, with the same high voltage, the electrical current can be increased 1.5 times when compared with single-wire electrically conducting elements.

When the system operates for a selected time the water clusters that are formed as described hereinabove continuously in increasing quantities, move upwards, and form clouds. The electrical voltage generated by the system 1 over the area A also provides regular latent heat in the atmosphere, creating a convective flow of the generated ions and water clusters to the heights of formation of clouds.

A high voltage electrical field is generated by the electrically conducting elements 2 and 3 to cover the substantially horizontal area A which is a fraction of a horizontal area of the cloud that is intended to be formed. For example, the total area A of the system 1 can be 5-15% of the horizontal area of the cloud to be formed.

The inventive system for stimulating a rainfall can have means which stimulate a transport of the cloud in a predetermined desired direction. For this purpose the system 1 can have two subsystems composed of the electrically conducting elements 2 and 3, spaced from each other and having different polarities so that the formed clouds move from one of the subsystems towards another subsystem.

During the operation of the system for stimulating a rainfall in accordance with the inventive method a high electric voltage is supplied to the electrically conductive elements 2 and 3 which cover the area A, and a high voltage electric field is generated, providing in the atmosphere movement of ions, ionization of gas molecules, generation of ions from the electrically conductive elements, which attract water and cause formation of a plurality of water clusters forming a cloud that can produce a rainfall. The rainfall can be produced from the thusly formed cloud when the cloud reaches a critical condition, with which the rainfall naturally occurs from clouds. On the other hand, the rainfall from the thusly formed cloud can be caused artificially.

The invention is not limited to the details shown, since various modifications and structural changes are possible without departing from the spirit of the invention.

What is desired to be protected by Letters Patent is set forth in the appended claims.

1. A system of stimulating a rainfall, comprising a plurality of electrically conducting elements which cover a substantially horizontal area and are constructed, when supplied with a high voltage electric current, to provide in the substantially horizonₜal area a high voltage electric field providing in the atmosphere ionization of gas molecules which attract water and cause formation of a plurality of water clusters forming a cloud that produce a rainfall.

2. The system of claim 1, wherein the electrically conducting elements include first electrically conducting elements which are arranged along a periphery of the system one after another, and second electrically conducting elements which extend centrally from the first electrically conducting elements.

3. The system of claim 1, wherein the electrically conducting elements are constructed as individual electrical conductors which are connected with each other to form the system.

4. The system of claim 1, wherein the electrically conducting elements are constructed as a single one-piece electrical conductor which is shaped to form the plurality of the electrically conducting elements.

5. The system of claim 1, wherein the electrically conducting elements are constructed as multi-wire electrically conducting elements.

6. The system of claim 1, wherein the electrically conducting elements are constructed to heat the atmosphere and thereby to provide a vertical upward flow of the ions and a vertical upward flow of the clusters to a desired height of the cloud to be formed.

7. The system of claim 1, wherein the electrically conducting elements are constructed to cover the substantially horizontal area which is a fraction of a horizontal area of the cloud that is desired to be formed.

8. The system of claim 1, further comprising transport stimulating means which stimulate a transport of the cloud to a desired direction.

9. The system of claim 1, further comprising an electric source constructed to supply a high electrical voltage to the electrically conducting elements.

10. The system of claim 9, wherein the source of electrical voltage is provided with a controller for controlling electric parameters of the electrical voltage supplied by the voltage source to the electrically conducting elements.

11. A method of stimulating a rainfall, comprising the steps of providing a plurality of electrically conducting elements which cover a substantially horizontal area, and supplying a high voltage electric current to the electrically conducting elements, to generate in the substantially horizontal area a high voltage electric field providing in the atmosphere ionization of gas molecules which attract water and cause formation of a plurality of water clusters forming a cloud that produce a rainfall.

12. The method of claim 11, further comprising forming the electrically conducting elements to include first electrically conductive elements which are arranged along a periphery of the system, and second electrically conducting elements which extend centrally from the first electrically conducting elements.

13. The method of claim 11, further comprising constructing the electrically conducting elements as individual electrical conductors, and electrically connecting them with each other to form the inventive system.

14. The method of claim 11, further comprising constructing the electrically conducting elements as a single one-piece electrical conductor, and shaping the latter to form the plurality of the electrically conducting elements.

15. The method of claim 11, further comprising constructing the electrically conducting elements as multi-wire electrically conducting elements.

16. The method of claim 11, further comprising heating by electrically conducting elements the atmosphere to thereby to provide a vertical upward flow of the ions and a vertical upward flow of the clusters to a desired height of the cloud to be formed.

17. The method of claim 11, further comprising covering by the electrical conducting elements a substantially horizontal area which is fraction of a horizontal area of the cloud that is desired to be formed.

18. The method of claim 11, further comprising stimulating a transport of the cloud to a desired location.

19. The method of claim 11, further comprising using a source .of electrical voltage supply to supply a high electrical voltage to the electrically conducting elements.

20. The method of claim 19, further comprising providing the source of electrical voltage with a controller controlling electrical parameters of the electric voltage supplied by the electrical voltage source to the electrically conducting elements.
